(19) United States
(12) Patent Application Publication
(10) Pub. No.: US 2026/0087718 A1
(43) Pub. Date: Mar. 26, 2026

(54) Texture Multi-Fetch with Return Sequencing for Graphics Processors

(71) Applicant: Apple Inc., Cupertino, CA (US)

(72) Inventors: Christopher A. Burns, Austin, TX (US); Abhinav Golas, Burlingame, CA (US); Tyson J. Bergland, Sunnyvale, CA (US); Justin A. Hensley, Mountain View, CA (US); Mladen Wilder, Cambridge (GB)

(21) Appl. No.: 18/950,776

(22) Filed: Nov. 18, 2024

Related U.S. Application Data
(60) Provisional application No. 63/698,107, filed on Sep. 24, 2024.

(51) Int. Cl. G06T 15/00; G06F 9/38; G06T 15/04

(52) U.S. Cl. CPC G06T 15/005; G06F 9/3802; G06T 15/04

(57) ABSTRACT

Techniques are disclosed relating to texture accesses by a graphics processor. In some embodiments, shader processor circuitry executes a multi-fetch instruction that specifies an access location and shape information for a thread and return sequence information that indicates an ordering of return data for the multi-fetch instruction. Based on the multi-fetch instruction and the shape information, texture processor circuitry may access multiple texels of a surface stored by the texture storage circuitry (where a plurality of the multiple texels are accessed at least partially in parallel) and provide the accessed multiple texels to the shader processor circuitry for the thread, over multiple clock cycles, according to the ordering specified by the return sequence information. Disclosed techniques may advantageously improve texture sampling throughput, particularly in the absence of filtering samples.

The present application claims priority to U.S. Provisional App. No. 63/698,107, entitled “Texture Multi-Fetch with Return Sequencing for Graphics Processors,” filed Sep. 24, 2024, the disclosure of which is incorporated by reference herein in its entirety.

### BACKGROUND

### Technical Field

This disclosure relates generally to graphics processors and more particularly to retrieving texture data.

### Description of Related Art

Graphics processors may execute certain workloads for which the throughput of texture reads affects performance. For example, graphics processors may be used for image processing tasks (e.g., for camera effects and professional editing applications). These applications may use two-dimensional (2D) image filters and creation of supporting assets like image pyramids, potentially for processing on other circuitry blocks (e.g., machine learning accelerator hardware).

### BRIEF DESCRIPTION OF DRAWINGS

FIG. 1A is a diagram illustrating an overview of example graphics processing operations, according to some embodiments.

FIG. 1B is a block diagram illustrating an example graphics unit, according to some embodiments.

FIG. 2 is a block diagram illustrating example communication between shader circuitry and texture processing circuitry for a multi-fetch operation, according to some embodiments.

FIG. 3 is a block diagram illustrating example filter pipeline circuitry configured to map samples of a multi-fetch operations to sample lanes of a filter pipeline.

FIGS. 4A-4F are diagrams illustrating example multi-fetch shapes in texture space.

FIG. 5 is a diagram illustrating example multi-fetch locations and return data for multiple different threads, according to some embodiments.

FIG. 6 is a diagram illustrating an example multi-fetch instruction format, according to some embodiments.

FIG. 7 is a diagram illustrating example return sequence modes, according to some embodiments.

FIG. 8 is a flow diagram illustrating an example method, according to some embodiments.

FIG. 9 is a block diagram illustrating an example computing device, according to some embodiments.

FIG. 10 is a diagram illustrating example applications of disclosed systems and devices, according to some embodiments.

FIG. 11 is a block diagram illustrating an example computer-readable medium that stores circuit design information, according to some embodiments.

### DETAILED DESCRIPTION

Disclosed embodiments utilize a single sample instruction (and potentially a single corresponding micro-operation or command to a texture unit) to sample multiple texels. For example, a graphics shader core may execute a sample (e.g., smp) instruction, generate a multi-fetch command for a texture processing unit based on the sample instruction, and receive multiple texels worth of data in response to the multi-fetch command. The texture processing unit may return the data from a texture cache in general purpose registers, for example. Data from multiple texel accesses (and potentially multiple cache lines of a texture cache) may be returned in a given cycle, increasing texture read rate and bus utilization (although note that data for an overall multi-fetch operation may be returned over multiple cycles).

For example, instead of performing M×N point sample operations to access M×N texels of a texture, disclosed techniques may allow the texture processing unit to receive a single multi-fetch command to access the M×N texels (or generally, a smaller number of multi-fetch commands than M×N, depending on the supported multi-fetch size).

The filter pipelines may turn off filtering circuitry (e.g., configured to perform bilinear or bicubic filtering on retrieved texels) for multi-fetch operations, to return texel data without filtering. Because a device may include a texture cache with bandwidth to support filtering operations in which multiple texels are sampled to provide a given filtered sample result, this multi-fetch paradigm with filtering turned off may take advantage of the texture cache bandwidth and allow efficient use of bus capacity back to the shader core.

In some embodiments, the sample instruction encodes return sequence information that specifies how to sequence data from the multi-fetch operation. For example, data may be returned by component, column, row, thread, etc. depending on the return sequence mode.

The sample instruction may specify shape information for the set of texels to be retrieved, which may be encoded in various ways. For example, the shape information may indicate length and width in M×N texels to be fetched, indicate a geometric shape, indicate a direction, or some combination thereof. The sample instruction may specify a sparsity mask in conjunction with the shape information, which may also be encoded using various formats. For an M×N multi-fetch, the sparsity mask may indicate which texels in the M×N shape to fetch (other texels may be skipped).

In some embodiments, disclosed hardware may use fast point sampling techniques to assign samples to lanes of a filter pipeline. U.S. patent application Ser. No. 18/653,576, filed May 2, 2024 and titled “Mapping Texture Point Samples to Lanes of a Filter Pipeline” is incorporated by reference herein in its entirety and discusses example techniques that may be used with disclosed embodiments to map samples to lanes.

In various embodiments, disclosed techniques may advantageously improve throughput of accessing texel data, which may improve performance, reduce power consumption, or both for certain workloads.

### Graphics Processing Overview

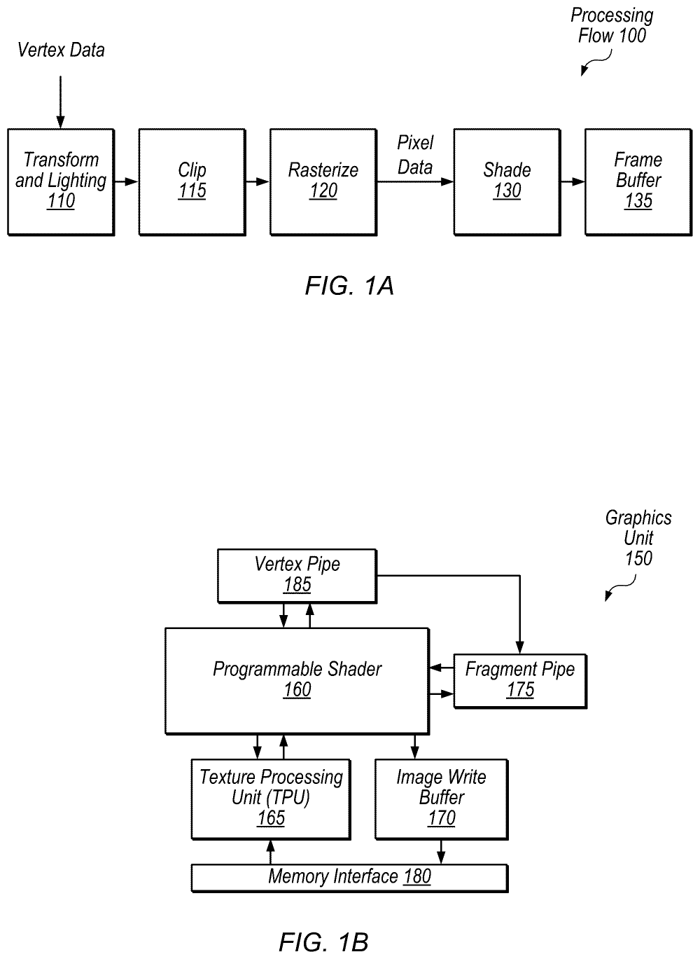

Referring to FIG. 1A, a flow diagram illustrating an example processing flow 100 for processing graphics data is shown. In some embodiments, transform and lighting procedure 110 may involve processing lighting information for vertices received from an application based on defined light source locations, reflectance, etc., assembling the vertices into polygons (e.g., triangles), and transforming the polygons to the correct size and orientation based on position in a three-dimensional space. Clip procedure 115 may involve discarding polygons or vertices that fall outside of a viewable area. In some embodiments, geometry processing may utilize object shaders and mesh shaders for flexibility and efficient processing prior to rasterization. Rasterize procedure 120 may involve defining fragments within each polygon and assigning initial color values for each fragment, e.g., based on texture coordinates of the vertices of the polygon. Fragments may specify attributes for pixels which they overlap, but the actual pixel attributes may be determined based on combining multiple fragments (e.g., in a frame buffer), ignoring one or more fragments (e.g., if they are covered by other objects), or both. Shade procedure 130 may involve altering pixel components based on lighting, shadows, bump mapping, translucency, etc. Shaded pixels may be assembled in a frame buffer 135. Modern GPUs typically include programmable shaders that allow customization of shading and other processing procedures by application developers. Thus, in various embodiments, the example elements of FIG. 1A may be performed in various orders, performed in parallel, or omitted. Additional processing procedures may also be implemented.

Referring now to FIG. 1B, a simplified block diagram illustrating a graphics unit 150 is shown, according to some embodiments. In the illustrated embodiment, graphics unit 150 includes programmable shader 160, vertex pipe 185, fragment pipe 175, texture processing unit (TPU) 165, image write buffer 170, and memory interface 180. In some embodiments, graphics unit 150 is configured to process both vertex and fragment data using programmable shader 160, which may be configured to process graphics data in parallel using multiple execution pipelines or instances.

Vertex pipe 185, in the illustrated embodiment, may include various fixed-function hardware configured to process vertex data. Vertex pipe 185 may be configured to communicate with programmable shader 160 in order to coordinate vertex processing. In the illustrated embodiment, vertex pipe 185 is configured to send processed data to fragment pipe 175 or programmable shader 160 for further processing.

Fragment pipe 175, in the illustrated embodiment, may include various fixed-function hardware configured to process pixel data. Fragment pipe 175 may be configured to communicate with programmable shader 160 in order to coordinate fragment processing. Fragment pipe 175 may be configured to perform rasterization on polygons from vertex pipe 185 or programmable shader 160 to generate fragment data. Vertex pipe 185 and fragment pipe 175 may be coupled to memory interface 180 (coupling not shown) in order to access graphics data.

Programmable shader 160, in the illustrated embodiment, is configured to receive vertex data from vertex pipe 185 and fragment data from fragment pipe 175 and TPU 165. Programmable shader 160 may be configured to perform vertex processing tasks on vertex data which may include various transformations and adjustments of vertex data. Programmable shader 160, in the illustrated embodiment, is also configured to perform fragment processing tasks on pixel data such as texturing and shading, for example. Programmable shader 160 may include multiple sets of multiple execution pipelines for processing data in parallel.

In some embodiments, programmable shader includes pipelines configured to execute one or more different SIMD groups in parallel. Each pipeline may include various stages configured to perform operations in a given clock cycle, such as fetch, decode, issue, execute, etc. The concept of a processor “pipeline” is well understood, and refers to the concept of splitting the “work” a processor performs on instructions into multiple stages. In some embodiments, instruction decode, dispatch, execution (i.e., performance), and retirement may be examples of different pipeline stages. Many different pipeline architectures are possible with varying orderings of elements/portions. Various pipeline stages perform such steps on an instruction during one or more processor clock cycles, then pass the instruction or operations associated with the instruction on to other stages for further processing.

The term “SIMD group” is intended to be interpreted according to its well-understood meaning, which includes a set of threads for which processing hardware processes the same instruction in parallel using different input data for the different threads. SIMD groups may also be referred to as SIMT (single-instruction, multiple-thread) groups, single instruction parallel thread (SIPT), or lane-stacked threads. Various types of computer processors may include sets of pipelines configured to execute SIMD instructions. For example, graphics processors often include programmable shader cores that are configured to execute instructions for a set of related threads in a SIMD fashion. Other examples of names that may be used for a SIMD group include: a wavefront, a clique, or a warp. A SIMD group may be a part of a larger threadgroup of threads that execute the same program, which may be broken up into a number of SIMD groups (within which threads may execute in lockstep) based on the parallel processing capabilities of a computer. In some embodiments, each thread is assigned to a hardware pipeline (which may be referred to as a “lane”) that fetches operands for that thread and performs the specified operations in parallel with other pipelines for the set of threads. Note that processors may have a large number of pipelines such that multiple separate SIMD groups may also execute in parallel. In some embodiments, each thread has private operand storage, e.g., in a register file. Thus, a read of a particular register from the register file may provide the version of the register for each thread in a SIMD group.

As used herein, the term “thread” includes its well-understood meaning in the art and refers to sequence of program instructions that can be scheduled for execution independently of other threads. Multiple threads may be included in a SIMD group to execute in lock-step. Multiple threads may be included in a task or process (which may correspond to a computer program). Threads of a given task may or may not share resources such as registers and memory. Thus, context switches may or may not be performed when switching between threads of the same task.

In some embodiments, multiple programmable shader units 160 are included in a GPU. In these embodiments, global control circuitry may assign work to the different sub-portions of the GPU which may in turn assign work to shader cores to be processed by shader pipelines.

TPU 165, in the illustrated embodiment, is configured to schedule fragment processing tasks from programmable shader 160. In some embodiments, TPU 165 is configured to pre-fetch texture data and assign initial colors to fragments for further processing by programmable shader 160 (e.g., via memory interface 180). TPU 165 may be configured to provide fragment components in normalized integer formats or floating-point formats, for example. In some embodiments, TPU 165 is configured to provide fragments in groups of four (a “fragment quad”) in a 2×2 format to be processed by a group of four execution pipelines in programmable shader 160.

Image write buffer 170, in some embodiments, is configured to store processed tiles of an image and may perform operations to a rendered image before it is transferred for display or to memory for storage. In some embodiments, graphics unit 150 is configured to perform tile-based deferred rendering (TBDR). In tile-based rendering, different portions of the screen space (e.g., squares or rectangles of pixels) may be processed separately. Memory interface 180 may facilitate communications with one or more of various memory hierarchies in various embodiments.

As discussed above, graphics processors typically include specialized circuitry configured to perform certain graphics processing operations requested by a computing system. This may include fixed-function vertex processing circuitry, pixel processing circuitry, or texture sampling circuitry, for example. Graphics processors may also execute non-graphics compute tasks that may use GPU shader cores but may not use fixed-function graphics hardware. As one example, machine learning workloads (which may include inference, training, or both) are often assigned to GPUs because of their parallel processing capabilities. Thus, compute kernels executed by the GPU may include program instructions that specify machine learning tasks such as implementing neural network layers or other aspects of machine learning models to be executed by GPU shaders. In some scenarios, non-graphics workloads may also utilize specialized graphics circuitry, e.g., for a different purpose than originally intended.

Further, various circuitry and techniques discussed herein with reference to graphics processors may be implemented in other types of processors in other embodiments. Other types of processors may include general-purpose processors such as CPUs or machine learning or artificial intelligence accelerators with specialized parallel processing capabilities. These other types of processors may not be configured to execute graphics instructions or perform graphics operations. For example, other types of processors may not include fixed-function hardware that is included in typical GPUs. Machine learning accelerators may include specialized hardware for certain operations such as implementing neural network layers or other aspects of machine learning models. Speaking generally, there may be design tradeoffs between the memory requirements, computation capabilities, power consumption, and programmability of machine learning accelerators. Therefore, different implementations may focus on different performance goals. Developers may select from among multiple potential hardware targets for a given machine learning application, e.g., from among generic processors, GPUs, and different specialized machine learning accelerators.

### Overview of Texture Multi-Fetch Techniques

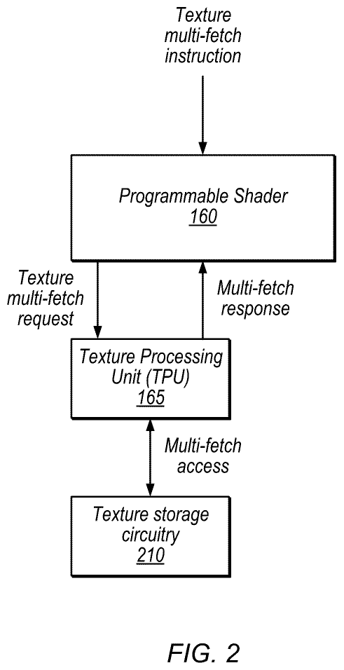

FIG. 2 is a block diagram illustrating example communication between shader circuitry and texture processing circuitry for a multi-fetch operation, according to some embodiments. In the illustrated example, a graphics processor includes programmable shader 160, texture processing unit 165, and texture storage circuitry 210.

Texture storage circuitry 210 may be a texture cache, for example, which may include entries configured to store texels or blocks of texels. In some embodiments, texel data is compressed for storage in one or more higher level caches of a cache/memory hierarchy but is stored in circuitry 210 in uncompressed form for fast access. In cache embodiments, circuitry 210 may be tagged using various appropriate information (e.g., texel address or coordinate information) and may utilize various techniques for determining hits and misses, allocation, eviction, etc. As mentioned above, circuitry 210 may be configured to access multiple texels or multiple cache entries in parallel, e.g., according to its entry size, number of read ports, number of banks, etc. For example, circuitry 210 may support accessing texel data in a single cycle for a filtering operation that generates a sample result based on N texels. In disclosed multi-fetch embodiments, TPU 165 may return all N texels for a single multi-fetch request from programmable shader 160 in the illustrated multi-fetch response. For example, TPU 165 may write the texel data to one or more general-purpose registers. For larger multi-fetch requests, TPU 165 may return multiple sets of up to N texels in different cycles.

As shown, programmable shader executes a single texture multi-fetch instruction (which may be an extended sample instruction, for example) and sends a single corresponding multi-fetch request to TPU 165, which accesses the requested texel data in circuitry 210 and provides the multi-fetch response to programmable shader 160 (potentially over a single cycle, depending on the size and the bus width to shader 160). The response may load texel data into general-purpose registers, for example.

### Example Mapping of Texel Accesses for a Multi-Fetch to Filter Lanes

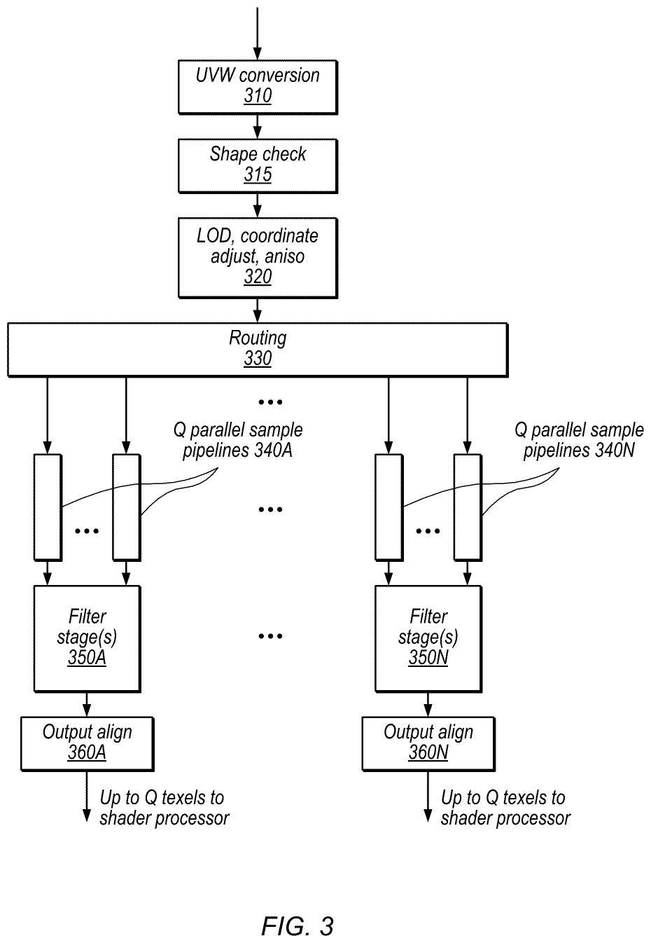

FIG. 3 is a block diagram illustrating example sample and filter pipeline circuitry configured to map samples of a multi-fetch operation to lanes of a filter pipeline. In the illustrated embodiment, TPU 165 includes pipeline circuitry that includes multiple filter pipelines (e.g., where a given filter pipeline includes stages 340-360). Each filter pipeline includes multiple filter lanes (e.g., sample pipelines 340). In some embodiments, the respective texel access operations of a multi-fetch request are mapped to different sample pipelines 340 of one or more filter pipelines.

UVW conversion circuitry 310, in some embodiments, is configured to calculate non-normalized UVW coordinates for incoming pixels (which may correspond to the number of threads in a SIMT group, for example). Note that UVW conversion 310 may include additional UVW converters relative to traditional techniques in order to handle additional samples according to disclosed techniques. This may provide a larger number of threads to a set of sample pipelines in a given cycle, relative to traditional techniques, when performing multi-fetch operations.

Shape check circuitry 315, in some embodiments, is configured to check multi-fetch texel locations to determine whether they match shapes supported by sets of sample pipelines 340. If the sample operations match a pre-determined shape or set of shapes, shape check circuitry 315 is configured to group the point samples and assign them to the same filter pipeline (e.g., one point sample operation to a given sample pipeline 340). If not, shape check circuitry 315 may send the point samples to different filter pipelines. Generally, shape check circuitry 315 may group point samples of a given M×N multi-fetch onto one or more filter pipelines.

For example, for a 4×4 multi-sample and filter pipelines that each include four sample pipelines 340 configured to sample a 2×2 quad of texels, shape circuitry 315 may assign the samples to four filter pipelines (or two filter pipelines over two cycles). As another example, for a 1×8 multi-sample and filter pipelines that each include four sample pipelines 340 configured to sample a 2×2 quad of texels, shape check circuitry 315 may assign two samples each to four filter pipelines (note that shape check circuitry 315 may also attempt to coalesce other samples, e.g., from other threads or other SIMT groups onto unused lanes, in this example). As another example, for a 1×8 multi-sample and filter pipelines that each include four sample pipelines 340 configured to sample a 1×4 set of texels, shape check circuitry 315 may assign four samples each to two filter pipelines. Various other examples are contemplated in which shape check circuitry 315 assigns groups of texel sample operations to different filter pipelines depending on the shape of the multi-fetch and the sample shape(s) supported by sample pipelines of a given filter pipeline.

In some embodiments, circuitry 315 or other control circuitry is configured to generate coordinates for multiple texels in a multi-fetch operation based on a smaller number of coordinates included in a multi-fetch instruction. For example, a multi-fetch instruction may specify a single coordinate and include shape information indicating other nearby texels that should also be fetched. Therefore, circuitry 320 or other control circuitry may generate coordinates for the other texels. In some embodiments, all the multi-fetch coordinates are integer coordinates corresponding to texel locations in the texture (thus, the coordinates may fall directly on a texel and not between texels). In other embodiments, the coordinates may be non-integer coordinates with nearest-texel semantics.

LOD, coordinate adjust, and aniso circuitry 320, in some embodiments, is configured to determine the level of detail for a sample, adjust coordinates in certain scenarios, perform aniso computations, and potentially other operations to prepare for sample operations by the pipelines 210. For MIP mapping situations, circuitry 320 may project UVW coordinates onto a coarse MIP map to check that the threads remain adjacent in the smaller map.

Routing circuitry 330, in some embodiments, is configured to route sample operations (potentially including some coalesced operations and some not within a given SIMT group), to the filter pipelines. For example, in bilinear embodiments, routing circuitry 330 may send up to four coalesced point sample operations with a 2×2 shape in texture space to one filter pipeline and a single point sample operation that did not coalesce to a different filter pipeline.

A given sample pipeline 340 may be configured to determine a texel address and access a texel based on received coordinates. For example, the pipeline 340 may then load the texel data from a texture cache (or from another level of a cache/memory hierarchy if there is a miss in the texture cache).

Filter stage(s) 350, in some embodiments, are configured to operate on loaded texture data to generate a filtered sample result. For example, for a bilinear filter operation, the filter stages 350 may include ALU circuitry configured to perform bilinear interpolation operations (e.g., using repeated linear interpolation or weighted average operations, which may use multiplier, adder, and reciprocal circuitry). As discussed above, control circuit may disable filter stage(s) 350 for multi-fetch operations and pass the texel data from pipelines 340 directly to output align circuitry 360.

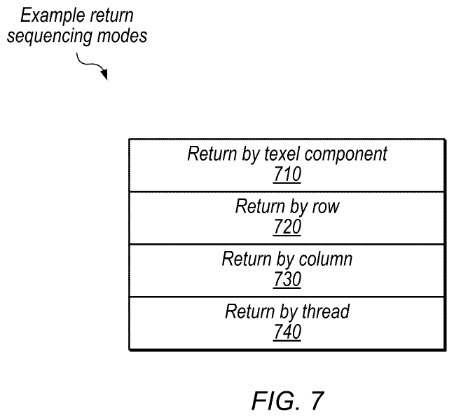

Output align circuitry 360, in some embodiments, is configured to assign outputs of the sample operations to the original threads. This may serialize the parallel outputs from the parallel pipelines within a sample/filter pipeline. In some embodiments, shape check circuitry 315, routing circuitry 330, output align circuitry 360, or some combination thereof are configured to handle retrieved texel data to deliver it to shader 160 according to a requested return sequence mode, as discussed below with reference to FIG. 7.

Generally, disclosed techniques for mapping individual texel point samples of a multi-fetch operations to filter lanes may substantially improve performance and reduce power consumption, e.g., relative to assigning a single texel point sample to each filter pipeline and leaving other sample pipelines 340 idle.

### Example Multi-Fetch Shapes

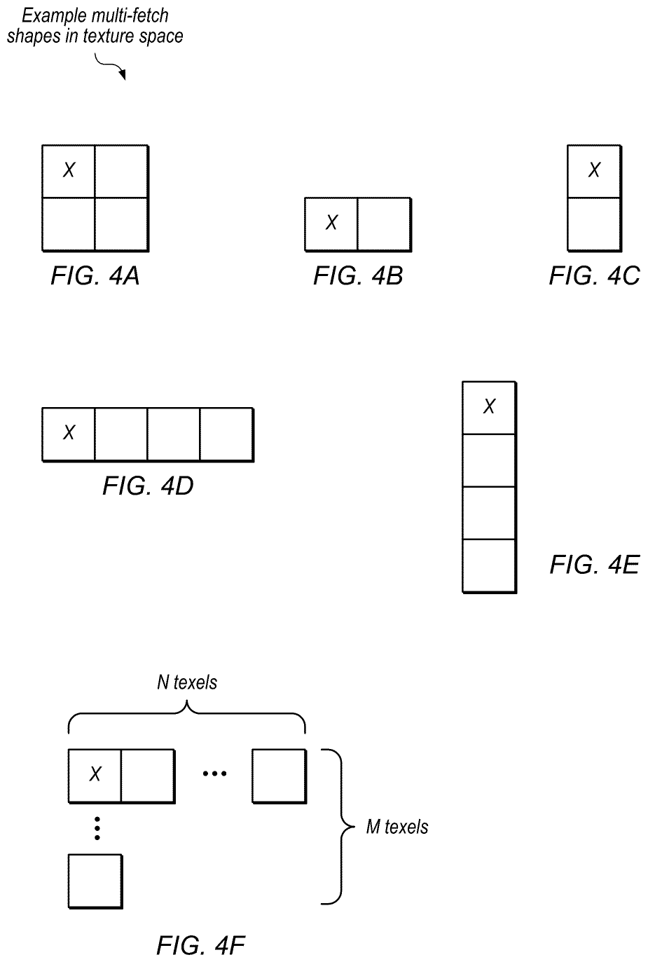

FIGS. 4A-4F are diagrams illustrating example multi-fetch shapes in texture space. In the illustrated example the square with the “X” represents the indicated coordinates for a multi-fetch instruction and other coordinates are implied based on the coordinates of the X location. In other embodiments, coordinates or relative offsets for multiple texels may be explicitly specified. The illustrated shapes are included for purposes of illustration but are not intended to limit the scope of the present disclosure.

Fix. 4A shows an example 2×2 multi-fetch of four texels.

FIG. 4B shows an example 1×2 multi-fetch of two texels.

FIG. 4C shows an example 2×1 multi-fetch of two texels.

FIG. 4D shows an example 1×4 multi-fetch of four texels.

FIG. 4E shows an example 4×1 multi-fetch of four texels.

FIG. 4F shows an example M×N multi-fetch of texels.

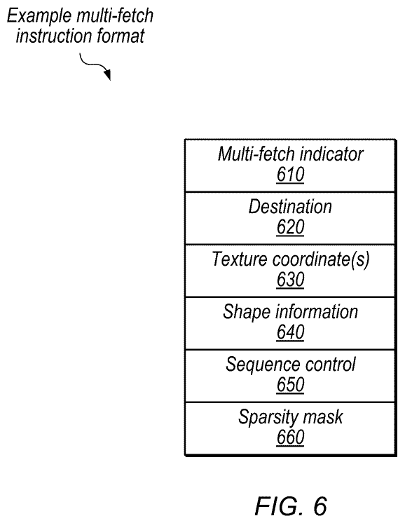

Note that a given multi-fetch pattern may fetch all texels in the pattern or may omit some texels. Detailed examples with non-full patterns are discussed below with reference to the sparsity mask of FIG. 6. Further, while the illustrated shapes are square or rectangular, other shapes are contemplated.

Note that an instruction may encode the shape of a multi-fetch in various ways. As one example, a field may encode one of multiple supported shapes. As another example, one field may encode a shape and another field encode a direction (e.g., a row of four texels could be horizontal or vertical or could be specified to extend up, down, left, or right from a specified anchor coordinate). As another example, separate fields may encode M and N dimensions. In still other embodiments, the shape may be implied, e.g., in implementations that support a single shape or limited number of shapes (where the shape might be implied based on the size, for example).

In some embodiments, multi-fetch may be applied to structures with three or more dimensions. In these embodiments, shapes information may be specified in additional dimensions.

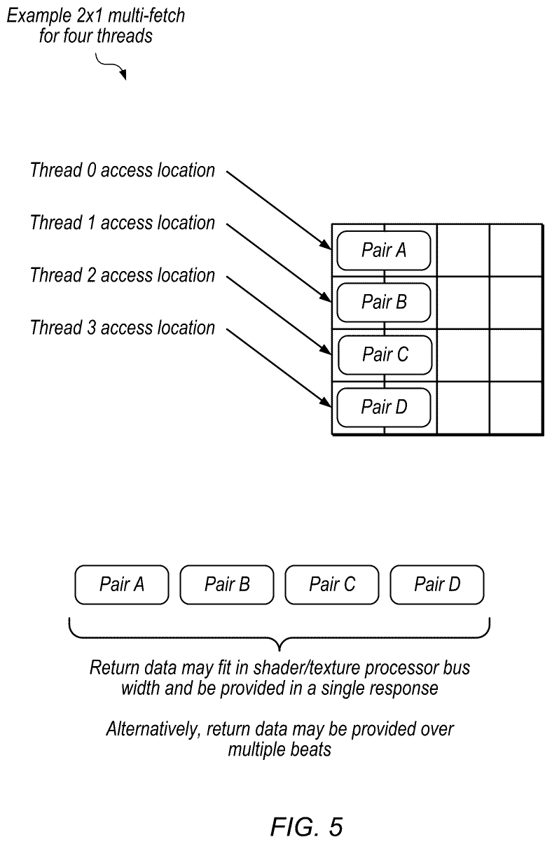

FIG. 5 is a diagram illustrating example multi-fetch locations and return data for multiple different threads, according to some embodiments. In the illustrated example, a 2×1 multi-fetch is performed for four threads (note that a multi-fetch instruction may execute for various numbers of threads, e.g., in SIMT embodiments and TPU 165 may process a corresponding command or micro-operation for all the threads at the same time or in one or more batches).

In the illustrated example, each thread has an access location (corresponding to a left-hand texel in the illustrated texel) and the multi-fetch also retrieves a texel to the right of the access location for that thread. Therefore, the multi-fetch retrieves texel pair A for thread 0, pair B for thread 1, pair C for thread 2, and pair D for thread 3.

As shown, the return data for the four threads may fit in the bus width between the shader 160 and TPU 165 and may be provided in a single response. In other embodiments or for greater multi-fetch sizes, the data may be returned over multiple beats over multiple clock cycles.

Note that the number of channels retrieved per texel may be configurable and the maximum size of a multi-fetch command may be based on the number of channels per texel, the number of bits per channel, the number of cycles over which results are to be returned, the number of threads per SIMT group, or some combination thereof.

### Example Multi-Fetch Instruction Format and Sequencing Modes

FIG. 6 is a diagram illustrating an example multi-fetch instruction format, according to some embodiments. In the illustrated example, a multi-fetch instruction includes a multi-fetch indicator 610, destination 620, texture coordinate(s) 630, shape information 640, sequence control 650, and sparsity mask 660.

Multi-fetch indicator 610, in some embodiments, indicates a multi-fetch instruction. This indicator may be part of the instruction's op-code or separately encoded. In some embodiments, multi-fetch indicator 610 indicates that a sample instruction is a multi-fetch.

Destination 620, in some embodiments, indicates the destination of the multiple texels to be fetched. For example, destination 620 may specify a single general-purpose register and the multi-fetch may store results in the following N general-purpose registers depending on the size of the multi-fetch. As another example, destination 620 may specify multiple registers. For SIMT embodiments texel results may be returned to different threads' versions of a given destination register. In some embodiments, the destination may indicate address(es) in a memory space, e.g., a threadgroup space or a shared memory space.

Texture coordinate(s) 630, in some embodiments, specify one or more locations within a texture. The coordinates may be specified in texture space or specified in another space and converted to texture space. In some embodiments, the coordinates are integer coordinates that fall on a given texel (rather than falling between texels in texture space). In SIMT embodiments, different threads'coordinates may have an implied or specified relationship to other threads' coordinates or may be independently specified. If a smaller number of coordinates are specified that the size of the multi-fetch, other coordinates may be determined based on other information (e.g., based on shape information 640).

Shape information 640, in some embodiments, indicates the shape of texels in texture space for the multi-fetch. For example, information 640 may specify one of the shapes shown in FIGS. 4A-4F and may be encoded as discussed with reference to those figures. For example, shape information 640 may specify a shape and orientation, width and height (and/or values for additional dimensions), a shape only, an orientation only, etc. In some embodiments shape and size are separately encoded.

Sequence control 650, in some embodiments, indicates the manner in which multi-fetch texel data is to be returned to shader 160. FIG. 7, discussed in detail below, provides example return sequence modes that may be encoded by sequence control 650. Different modes may improve processing performance by shader 160, e.g., depending on its use of the texel data.

Sparsity mask 660, in some embodiments, indicates one or more texels that fall within the shape specified by shape information 640, but should not be fetched as part of the multi-fetch operation. As one example, the sparsity mask may be encoded as a bit map with a bit for each texel in the shape that indicates whether or not that texel is requested. As another example, the sparsity mask may be encoded as a stride, e.g., such that a texel is fetched (or skipped) every N texels according to a predetermined traversal pattern within the shape. As another example, field 660 may be a pointer to sparsity mask location. (Generally, various disclosed fields may be encoded as immediate values, indicate a register that stores the values, indicate a pointer to a memory location that stores the values, etc.).

Note that all or a portion of the fields discussed with reference to a multi-fetch instruction executed by shader 160 may similarly be encoded in a command or micro-operation performed by TPU 165.

FIG. 7 is a diagram illustrating example return sequence modes, according to some embodiments. In the illustrated example, the GPU supports the following return sequencing modes: return by texel component 710, return by row 720, return by column 730, and return by thread 740.

Return by texel component returns all (or a specified portion) of retrieved texel data for one component (e.g., for a “red” channel in RGBA encodings) before returning data for other components.

Return by row returns results in row order while return by column returns results in column order, within an M×N multi-fetch shape. In other embodiments, results may be returned in blocks (e.g., different 2×2 blocks within a larger M×N shape). For other non-rectangular shapes, other geometrical orderings are contemplated.

Return by thread returns results for a given thread of a SIMT instruction before returning results for other threads. Various other return sequence modes are contemplated, in various combinations, and disclosed modes may be omitted. Generally, TPU 165 may determine how to replay results out of its internal texture cache or an internal buffer based on the sequencing mode. Different return sequences may improve shader efficiency and may synchronize with scheduler circuitry and shader execution. For example, shader 160 may be able to perform improved register footprint management based on the timing of return data (e.g., using a set of registers to process one component then re-use the set of registers for the next component in return-by-texel-component mode).

In some embodiments, TPU 165 includes buffer circuitry configured to buffer retrieved texel results and control circuitry configured to provide buffered data to the bus with shader 160 based on the return sequence mode. In other embodiments, TPU 165 may include control circuitry configured to sequence accesses to the texture cache based on the return sequence mode.

### Example Method

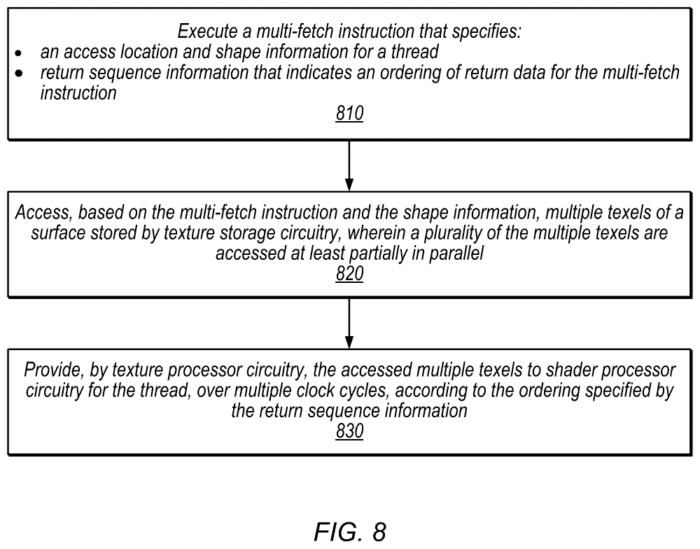

FIG. 8 is a flow diagram illustrating an example method, according to some embodiments. The method shown in FIG. 8 may be used in conjunction with any of the computer circuitry, systems, devices, elements, or components disclosed herein, among others. In various embodiments, some of the method elements shown may be performed concurrently, in a different order than shown, or may be omitted. Additional method elements may also be performed as desired.

At 810, in the illustrated embodiment, shader processing circuitry of a computing system executes a multi-fetch instruction that specifies: an access location and shape information for a thread and return sequence information that indicates an ordering of return data for the multi-fetch instruction. Note that the shape information is specified once for a SIMT group and the shape may be shared by threads in that SIMT group, in some embodiments (such that the shape is uniform across multi-sample operations for threads of the SIMT group, although the shapes may be sampled at different locations for different threads). In some embodiments, the shape information indicates a width and a height in texture space. In some embodiments, the access location is specified as an integer coordinate in a texture space.

At 820, in the illustrated embodiment, texture processor circuitry of the computing system accesses, based on the multi-fetch instruction and the shape information, multiple texels of a surface stored by texture storage circuitry, wherein a plurality of the multiple texels are accessed at least partially in parallel. In some embodiments, the texture processor circuitry is configured to access the multiple texels from the texture storage circuitry in a single clock cycle. In other embodiments, the texture processor circuitry may access different subsets of the multiple texels from the texture storage circuitry over multiple different clock cycles. In some embodiments, the texture storage circuitry is a texture cache with entries that are tagged based on locations in texture space.

At 830, in the illustrated embodiment, the texture processor circuitry provides the accessed multiple texels to the shader processor circuitry for the thread, over multiple clock cycles, according to the ordering specified by the return sequence information. In some embodiments, the texture processor circuitry is configured to store the multiple accessed texels in multiple general-purpose registers of the shader processor circuitry.

In some embodiments, the texture processor circuitry includes filter circuitry (e.g., bilinear filter circuitry) configured to perform filter operations on multiple accessed texels. The texture processor circuitry may disable the filter circuitry for the multi-fetch instruction and provide the multiple texels without filtering.

In some embodiments, the texture processing circuitry includes: a first filter pipeline that includes a first set of multiple sample lanes (e.g., sample pipelines 340A) and a second filter pipeline that includes a second set of multiple sample lanes (e.g., sample pipeline 340N). Control circuitry may map the accesses to the multiple texels of the surface to multiple samples lanes of the first set of multiple sample lanes and to multiple sample lanes of the second set of multiple sample lanes.

In some embodiments, the multi-fetch instruction further specifies sparsity mask information that indicates a subset of texels within a shape specified by the shape information and the multiple texels accessed and provided by the texture processor circuitry include only the subset of texels and does not include one or more other texels within the shape.

In some embodiments, the multi-fetch instruction is a SIMT sample instruction and the texture processor circuitry is configured to access multiple texels of the texture for a first SIMT thread and multiple texels of the texture for a second SIMT thread.

The concept of “execution” is broad and may refer to 1) processing of an instruction throughout an execution pipeline (e.g., through fetch, decode, execute, and retire stages) and 2) processing of an instruction at an execution unit or execution subsystem of such a pipeline (e.g., an integer execution unit or a load-store unit). The latter meaning may also be referred to as “performing” the instruction. Thus, “performing” an add instruction refers to adding two operands to produce a result, which may, in some embodiments, be accomplished by a circuit at an execute stage of a pipeline (e.g., an execution unit). Conversely, “executing” the add instruction may refer to the entirety of operations that occur throughout the pipeline as a result of the add instruction. Similarly, “performing” a “load” instruction may include retrieving a value (e.g., from a cache, memory, or stored result of another instruction) and storing the retrieved value into a register or other location.

As used herein the terms “complete” and “completion” in the context of an instruction refer to commitment of the instruction's result(s) to the architectural state of a processor or processing element. For example, completion of an add instruction includes writing the result of the add instruction to a destination register. Similarly, completion of a load instruction includes writing a value (e.g., a value retrieved from a cache or memory) to a destination register or a representation thereof.

The concept of a processor “pipeline” is well understood, and refers to the concept of splitting the “work” a processor performs on instructions into multiple stages. In some embodiments, instruction decode, dispatch, execution (i.e., performance), and retirement may be examples of different pipeline stages. Many different pipeline architectures are possible with varying orderings of elements/portions. Various pipeline stages perform such steps on an instruction during one or more processor clock cycles, then pass the instruction or operations associated with the instruction on to other stages for further processing.

As used herein, the terms “clock” and “clock signal” refer to a periodic signal, e.g., as in a two-valued (binary) electrical signal. A clock periodically changes between “levels” of the clock such as voltage ranges of an electrical signal. For example, voltages greater than 0.7 volts may be used to represent one clock level and voltages lower than 0.3 volts may be used to represent another level in a binary configuration. As used herein, the term “clock edge” refers to a change in a clock signal from one level to another level. As used herein, the term “toggle” in the context of a clock signal refers to changing the value of the clock signal from one level to another level in a binary clock configuration. As used herein, the term clock “pulse” refers to an interval of a clock signal between consecutive edges of the clock signal (e.g., an interval between a rising edge and a falling edge or an interval between a falling edge and a rising edge). Note that sequential circuitry may perform operations on a rising edge of a clock signal, a falling edge of a clock signal, or both (which may be referred to as dual-edge triggered).

### Example Device

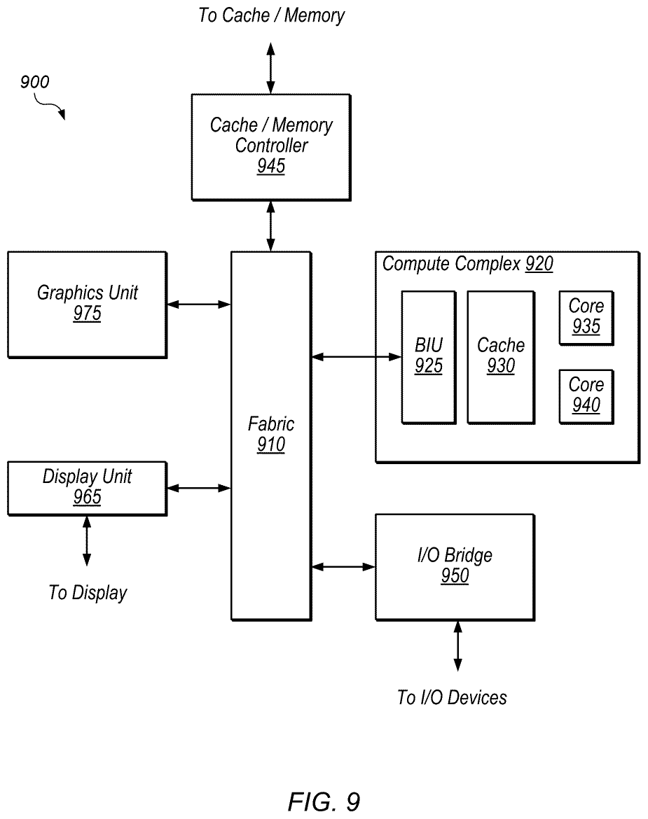

Referring now to FIG. 9, a block diagram illustrating an example embodiment of a device 900 is shown. In some embodiments, elements of device 900 may be included within a system on a chip. In some embodiments, device 900 may be included in a mobile device, which may be battery-powered. Therefore, power consumption by device 900 may be an important design consideration. In the illustrated embodiment, device 900 includes fabric 910, compute complex 920 input/output (I/O) bridge 950, cache/memory controller 945, graphics unit 975, and display unit 965. In some embodiments, device 900 may include other components (not shown) in addition to or in place of the illustrated components, such as video processor encoders and decoders, image processing or recognition elements, computer vision elements, etc.

Fabric 910 may include various interconnects, buses, MUX's, controllers, etc., and may be configured to facilitate communication between various elements of device 900. In some embodiments, portions of fabric 910 may be configured to implement various different communication protocols. In other embodiments, fabric 910 may implement a single communication protocol and elements coupled to fabric 910 may convert from the single communication protocol to other communication protocols internally.

In the illustrated embodiment, compute complex 920 includes bus interface unit (BIU) 925, cache 930, and cores 935 and 940. In various embodiments, compute complex 920 may include various numbers of processors, processor cores and caches. For example, compute complex 920 may include 1, 2, or 4 processor cores, or any other suitable number. In one embodiment, cache 930 is a set associative L2 cache. In some embodiments, cores 935 and 940 may include internal instruction and data caches. In some embodiments, a coherency unit (not shown) in fabric 910, cache 930, or elsewhere in device 900 may be configured to maintain coherency between various caches of device 900. BIU 925 may be configured to manage communication between compute complex 920 and other elements of device 900. Processor cores such as cores 935 and 940 may be configured to execute instructions of a particular instruction set architecture (ISA) which may include operating system instructions and user application instructions. These instructions may be stored in computer readable medium such as a memory coupled to memory controller 945 discussed below.

As used herein, the term “coupled to” may indicate one or more connections between elements, and a coupling may include intervening elements. For example, in FIG. 9, graphics unit 975 may be described as “coupled to” a memory through fabric 910 and cache/memory controller 945. In contrast, in the illustrated embodiment of FIG. 9, graphics unit 975 is “directly coupled” to fabric 910 because there are no intervening elements.

Cache/memory controller 945 may be configured to manage transfer of data between fabric 910 and one or more caches and memories. For example, cache/memory controller 945 may be coupled to an L3 cache, which may in turn be coupled to a system memory. In other embodiments, cache/memory controller 945 may be directly coupled to a memory. In some embodiments, cache/memory controller 945 may include one or more internal caches. Memory coupled to controller 945 may be any type of volatile memory, such as dynamic random access memory (DRAM), synchronous DRAM (SDRAM), double data rate (DDR, DDR2, DDR3, etc.) SDRAM (including mobile versions of the SDRAMs such as mDDR3, etc., and/or low power versions of the SDRAMs such as LPDDR4, etc.), RAMBUS DRAM (RDRAM), static RAM (SRAM), etc. One or more memory devices may be coupled onto a circuit board to form memory modules such as single inline memory modules (SIMMs), dual inline memory modules (DIMMs), etc. Alternatively, the devices may be mounted with an integrated circuit in a chip-on-chip configuration, a package-on-package configuration, or a multi-chip module configuration. Memory coupled to controller 945 may be any type of non-volatile memory such as NAND flash memory, NOR flash memory, nano RAM (NRAM), magneto-resistive RAM (MRAM), phase change RAM (PRAM), Racetrack memory, Memristor memory, etc. As noted above, this memory may store program instructions executable by compute complex 920 to cause the computing device to perform functionality described herein.

Graphics unit 975 may include one or more processors, e.g., one or more graphics processing units (GPUs). Graphics unit 975 may receive graphics-oriented instructions, such as VULKAN®, Metal®, or DIRECTX® instructions, for example. Graphics unit 975 may execute specialized GPU instructions or perform other operations based on the received graphics-oriented instructions. Graphics unit 975 may generally be configured to process large blocks of data in parallel and may build images in a frame buffer for output to a display, which may be included in the device or may be a separate device. Graphics unit 975 may include transform, lighting, triangle, and rendering engines in one or more graphics processing pipelines. Graphics unit 975 may output pixel information for display images. Graphics unit 975, in various embodiments, may include programmable shader circuitry which may include highly parallel execution cores configured to execute graphics programs, which may include pixel tasks, vertex tasks, and compute tasks (which may or may not be graphics-related).

In some embodiments, graphics unit 975 may implement various disclosed texture multi-fetch techniques, which may improve throughput in accessing texture data for further processing by graphics unit 975 or for other components of the illustrated system (e.g., an image processor, a machine learning or artificial intelligence accelerator, etc.).

Display unit 965 may be configured to read data from a frame buffer and provide a stream of pixel values for display. Display unit 965 may be configured as a display pipeline in some embodiments. Additionally, display unit 965 may be configured to blend multiple frames to produce an output frame. Further, display unit 965 may include one or more interfaces (e.g., MIPI® or embedded display port (eDP)) for coupling to a user display (e.g., a touchscreen or an external display).

I/O bridge 950 may include various elements configured to implement: universal serial bus (USB) communications, security, audio, and low-power always-on functionality, for example. I/O bridge 950 may also include interfaces such as pulse-width modulation (PWM), general-purpose input/output (GPIO), serial peripheral interface (SPI), and inter-integrated circuit (I2C), for example. Various types of peripherals and devices may be coupled to device 900 via I/O bridge 950.

In some embodiments, device 900 includes network interface circuitry (not explicitly shown), which may be connected to fabric 910 or I/O bridge 950. The network interface circuitry may be configured to communicate via various networks, which may be wired, wireless, or both. For example, the network interface circuitry may be configured to communicate via a wired local area network, a wireless local area network (e.g., via Wi-Fi™), or a wide area network (e.g., the Internet or a virtual private network). In some embodiments, the network interface circuitry is configured to communicate via one or more cellular networks that use one or more radio access technologies. In some embodiments, the network interface circuitry is configured to communicate using device-to-device communications (e.g., Bluetooth® or Wi-Fi™ Direct), etc. In various embodiments, the network interface circuitry may provide device 900 with connectivity to various types of other devices and networks.

### Example Applications

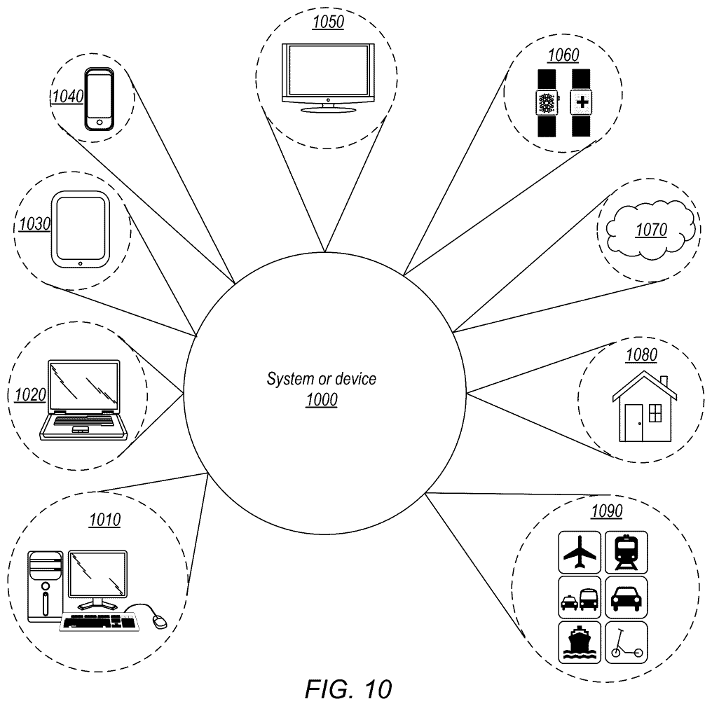

Turning now to FIG. 10, various types of systems that may include any of the circuits, devices, or system discussed above. System or device 1000, which may incorporate or otherwise utilize one or more of the techniques described herein, may be utilized in a wide range of areas. For example, system or device 1000 may be utilized as part of the hardware of systems such as a desktop computer 1010, laptop computer 1020, tablet computer 1030, cellular or mobile phone 1040, or television 1050 (or set-top box coupled to a television).

Similarly, disclosed elements may be utilized in a wearable device 1060, such as a smartwatch or a health-monitoring device. Smartwatches, in many embodiments, may implement a variety of different functions—for example, access to email, cellular service, calendar, health monitoring, etc. A wearable device may also be designed solely to perform health-monitoring functions, such as monitoring a user's vital signs, performing epidemiological functions such as contact tracing, providing communication to an emergency medical service, etc. Other types of devices are also contemplated, including devices worn on the neck, devices implantable in the human body, glasses or a helmet designed to provide computer-generated reality experiences such as those based on augmented and/or virtual reality, etc.

System or device 1000 may also be used in various other contexts. For example, system or device 1000 may be utilized in the context of a server computer system, such as a dedicated server or on shared hardware that implements a cloud-based service 1070. Still further, system or device 1000 may be implemented in a wide range of specialized everyday devices, including devices 1080 commonly found in the home such as refrigerators, thermostats, security cameras, etc. The interconnection of such devices is often referred to as the “Internet of Things” (IoT). Elements may also be implemented in various modes of transportation. For example, system or device 1000 could be employed in the control systems, guidance systems, entertainment systems, etc. of various types of vehicles 1090.

The applications illustrated in FIG. 10 are merely exemplary and are not intended to limit the potential future applications of disclosed systems or devices. Other example applications include, without limitation: portable gaming devices, music players, data storage devices, unmanned aerial vehicles, etc.

### Example Computer-Readable Medium

The present disclosure has described various example circuits in detail above. It is intended that the present disclosure cover not only embodiments that include such circuitry, but also a computer-readable storage medium that includes design information that specifies such circuitry. Accordingly, the present disclosure is intended to support claims that cover not only an apparatus that includes the disclosed circuitry, but also a storage medium that specifies the circuitry in a format that programs a computing system to generate a simulation model of the hardware circuit, programs a fabrication system configured to produce hardware (e.g., an integrated circuit) that includes the disclosed circuitry, etc. Claims to such a storage medium are intended to cover, for example, an entity that produces a circuit design, but does not itself perform complete operations such as: design simulation, design synthesis, circuit fabrication, etc.

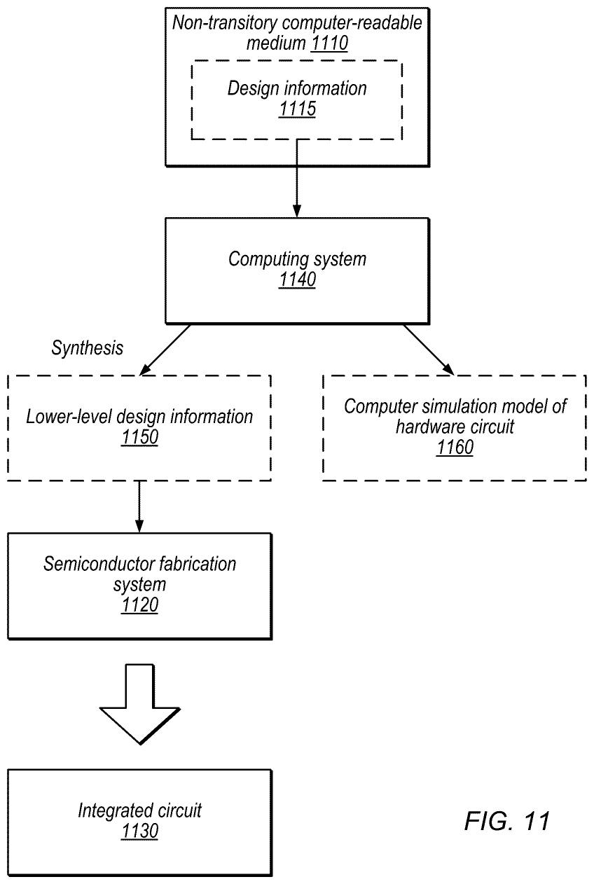

FIG. 11 is a block diagram illustrating an example non-transitory computer-readable storage medium that stores circuit design information, according to some embodiments. In the illustrated embodiment, computing system 1140 is configured to process the design information. This may include executing instructions included in the design information, interpreting instructions included in the design information, compiling, transforming, or otherwise updating the design information, etc. Therefore, the design information controls computing system 1140 (e.g., by programming computing system 1140) to perform various operations discussed below, in some embodiments.

In the illustrated example, computing system 1140 processes the design information to generate both a computer simulation model of a hardware circuit 1160 and lower-level design information 1150. In other embodiments, computing system 1140 may generate only one of these outputs, may generate other outputs based on the design information, or both. Regarding the computing simulation, computing system 1140 may execute instructions of a hardware description language that includes register transfer level (RTL) code, behavioral code, structural code, or some combination thereof. The simulation model may perform the functionality specified by the design information, facilitate verification of the functional correctness of the hardware design, generate power consumption estimates, generate timing estimates, etc.

In the illustrated example, computing system 1140 also processes the design information to generate lower-level design information 1150 (e.g., gate-level design information, a netlist, etc.). This may include synthesis operations, as shown, such as constructing a multi-level network, optimizing the network using technology-independent techniques, technology dependent techniques, or both, and outputting a network of gates (with potential constraints based on available gates in a technology library, sizing, delay, power, etc.). Based on lower-level design information 1150 (potentially among other inputs), semiconductor fabrication system 1120 is configured to fabricate an integrated circuit 1130 (which may correspond to functionality of the simulation model 1160). Note that computing system 1140 may generate different simulation models based on design information at various levels of description, including information 1150, 1115, and so on. The data representing design information 1150 and model 1160 may be stored on medium 1110 or on one or more other media.

In some embodiments, the lower-level design information 1150 controls (e.g., programs) the semiconductor fabrication system 1120 to fabricate the integrated circuit 1130. Thus, when processed by the fabrication system, the design information may program the fabrication system to fabricate a circuit that includes various circuitry disclosed herein.

Non-transitory computer-readable storage medium 1110, may comprise any of various appropriate types of memory devices or storage devices. Non-transitory computer-readable storage medium 1110 may be an installation medium, e.g., a CD-ROM, floppy disks, or tape device; a computer system memory or random access memory such as DRAM, DDR RAM, SRAM, EDO RAM, Rambus RAM, etc. ; a non-volatile memory such as a Flash, magnetic media, e.g., a hard drive, or optical storage; registers, or other similar types of memory elements, etc. Non-transitory computer-readable storage medium 1110 may include other types of non-transitory memory as well or combinations thereof. Accordingly, non-transitory computer-readable storage medium 1110 may include two or more memory media; such media may reside in different locations—for example, in different computer systems that are connected over a network.

Design information 1115 may be specified using any of various appropriate computer languages, including hardware description languages such as, without limitation: VHDL, Verilog, SystemC, SystemVerilog, RHDL, M, MyHDL, etc. The format of various design information may be recognized by one or more applications executed by computing system 1140, semiconductor fabrication system 1120, or both. In some embodiments, design information may also include one or more cell libraries that specify the synthesis, layout, or both of integrated circuit 1130. In some embodiments, the design information is specified in whole or in part in the form of a netlist that specifies cell library elements and their connectivity. Design information discussed herein, taken alone, may or may not include sufficient information for fabrication of a corresponding integrated circuit. For example, design information may specify the circuit elements to be fabricated but not their physical layout. In this case, design information may be combined with layout information to actually fabricate the specified circuitry.

Integrated circuit 1130 may, in various embodiments, include one or more custom macrocells, such as memories, analog or mixed-signal circuits, and the like. In such cases, design information may include information related to included macrocells. Such information may include, without limitation, schematics capture database, mask design data, behavioral models, and device or transistor level netlists. Mask design data may be formatted according to graphic data system (GDSII), or any other suitable format.

Semiconductor fabrication system 1120 may include any of various appropriate elements configured to fabricate integrated circuits. This may include, for example, elements for depositing semiconductor materials (e.g., on a wafer, which may include masking), removing materials, altering the shape of deposited materials, modifying materials (e.g., by doping materials or modifying dielectric constants using ultraviolet processing), etc. Semiconductor fabrication system 1120 may also be configured to perform various testing of fabricated circuits for correct operation.

In various embodiments, integrated circuit 1130 and model 1160 are configured to operate according to a circuit design specified by design information 1115, which may include performing any of the functionality described herein. For example, integrated circuit 1130 may include any of various elements shown in FIGS. 1B-3, and 9. Further, integrated circuit 1130 may be configured to perform various functions described herein in conjunction with other components. Further, the functionality described herein may be performed by multiple connected integrated circuits.

As used herein, a phrase of the form “design information that specifies a design of a circuit configured to . . . ” does not imply that the circuit in question must be fabricated in order for the element to be met. Rather, this phrase indicates that the design information describes a circuit that, upon being fabricated, will be configured to perform the indicated actions or will include the specified components. Similarly, stating “instructions of a hardware description programming language” that are “executable” to program a computing system to generate a computer simulation model does not imply that the instructions must be executed in order for the element to be met, but rather specifies characteristics of the instructions. Additional features relating to the model (or the circuit represented by the model) may similarly relate to characteristics of the instructions, in this context. Therefore, an entity that sells a computer-readable medium with instructions that satisfy recited characteristics may provide an infringing product, even if another entity actually executes the instructions on the medium.

Note that a given design, at least in the digital logic context, may be implemented using a multitude of different gate arrangements, circuit technologies, etc. As one example, different designs may select or connect gates based on design tradeoffs (e.g., to focus on power consumption, performance, circuit area, etc.). Further, different manufacturers may have proprietary libraries, gate designs, physical gate implementations, etc. Different entities may also use different tools to process design information at various layers (e.g., from behavioral specifications to physical layout of gates).

Once a digital logic design is specified, however, those skilled in the art need not perform substantial experimentation or research to determine those implementations. Rather, those of skill in the art understand procedures to reliably and predictably produce one or more circuit implementations that provide the function described by the design information. The different circuit implementations may affect the performance, area, power consumption, etc. of a given design (potentially with tradeoffs between different design goals), but the logical function does not vary among the different circuit implementations of the same circuit design.

In some embodiments, the instructions included in the design information instructions provide RTL information (or other higher-level design information) and are executable by the computing system to synthesize a gate-level netlist that represents the hardware circuit based on the RTL information as an input. Similarly, the instructions may provide behavioral information and be executable by the computing system to synthesize a netlist or other lower-level design information. The lower-level design information may program fabrication system 1120 to fabricate integrated circuit 1130.

The various techniques described herein may be performed by one or more computer programs. The term “program” is to be construed broadly to cover a sequence of instructions in a programming language that a computing device can execute. These programs may be written in any suitable computer language, including lower-level languages such as assembly and higher-level languages such as Python. The program may be written in a compiled language such as C or C++, or an interpreted language such as JavaScript.

Program instructions may be stored on a “computer-readable storage medium” or a “computer-readable medium” in order to facilitate execution of the program instructions by a computer system. Generally speaking, these phrases include any tangible or non-transitory storage or memory medium. The terms “tangible” and “non-transitory” are intended to exclude propagating electromagnetic signals, but not to otherwise limit the type of storage medium. Accordingly, the phrases “computer-readable storage medium” or a “computer-readable medium” are intended to cover types of storage devices that do not necessarily store information permanently (e.g., random access memory (RAM)). The term “non-transitory,” accordingly, is a limitation on the nature of the medium itself (i.e., the medium cannot be a signal) as opposed to a limitation on data storage persistency of the medium (e.g., RAM vs. ROM).

The phrases “computer-readable storage medium” and “computer-readable medium” are intended to refer to both a storage medium within a computer system as well as a removable medium such as a CD-ROM, memory stick, or portable hard drive. The phrases cover any type of volatile memory within a computer system including DRAM, DDR RAM, SRAM, EDO RAM, Rambus RAM, etc., as well as non-volatile memory such as magnetic media, e.g., a hard drive, or optical storage. The phrases are explicitly intended to cover the memory of a server that facilitates downloading of program instructions, the memories within any intermediate computer system involved in the download, as well as the memories of all destination computing devices. Still further, the phrases are intended to cover combinations of different types of memories.

In addition, a computer-readable medium or storage medium may be located in a first set of one or more computer systems in which the programs are executed, as well as in a second set of one or more computer systems which connect to the first set over a network. In the latter instance, the second set of computer systems may provide program instructions to the first set of computer systems for execution. In short, the phrases “computer-readable storage medium” and “computer-readable medium” may include two or more media that may reside in different locations, e.g., in different computers that are connected over a network.

The present disclosure includes references to “an embodiment” or groups of “embodiments” (e.g., “some embodiments” or “various embodiments”). Embodiments are different implementations or instances of the disclosed concepts. References to “an embodiment,” “one embodiment,” “a particular embodiment,” and the like do not necessarily refer to the same embodiment. A large number of possible embodiments are contemplated, including those specifically disclosed, as well as modifications or alternatives that fall within the spirit or scope of the disclosure.

This disclosure may discuss potential advantages that may arise from the disclosed embodiments. Not all implementations of these embodiments will necessarily manifest any or all of the potential advantages. Whether an advantage is realized for a particular implementation depends on many factors, some of which are outside the scope of this disclosure. In fact, there are a number of reasons why an implementation that falls within the scope of the claims might not exhibit some or all of any disclosed advantages. For example, a particular implementation might include other circuitry outside the scope of the disclosure that, in conjunction with one of the disclosed embodiments, negates or diminishes one or more of the disclosed advantages. Furthermore, suboptimal design execution of a particular implementation (e.g., implementation techniques or tools) could also negate or diminish disclosed advantages. Even assuming a skilled implementation, realization of advantages may still depend upon other factors such as the environmental circumstances in which the implementation is deployed. For example, inputs supplied to a particular implementation may prevent one or more problems addressed in this disclosure from arising on a particular occasion, with the result that the benefit of its solution may not be realized. Given the existence of possible factors external to this disclosure, it is expressly intended that any potential advantages described herein are not to be construed as claim limitations that must be met to demonstrate infringement. Rather, identification of such potential advantages is intended to illustrate the type(s) of improvement available to designers having the benefit of this disclosure. That such advantages are described permissively (e.g., stating that a particular advantage “may arise”) is not intended to convey doubt about whether such advantages can in fact be realized, but rather to recognize the technical reality that realization of such advantages often depends on additional factors.

Unless stated otherwise, embodiments are non-limiting. That is, the disclosed embodiments are not intended to limit the scope of claims that are drafted based on this disclosure, even where only a single example is described with respect to a particular feature. The disclosed embodiments are intended to be illustrative rather than restrictive, absent any statements in the disclosure to the contrary. The application is thus intended to permit claims covering disclosed embodiments, as well as such alternatives, modifications, and equivalents that would be apparent to a person skilled in the art having the benefit of this disclosure.

For example, features in this application may be combined in any suitable manner. Accordingly, new claims may be formulated during prosecution of this application (or an application claiming priority thereto) to any such combination of features. In particular, with reference to the appended claims, features from dependent claims may be combined with those of other dependent claims where appropriate, including claims that depend from other independent claims. Similarly, features from respective independent claims may be combined where appropriate.

Accordingly, while the appended dependent claims may be drafted such that each depends on a single other claim, additional dependencies are also contemplated. Any combinations of features in the dependent that are consistent with this disclosure are contemplated and may be claimed in this or another application. In short, combinations are not limited to those specifically enumerated in the appended claims.

Where appropriate, it is also contemplated that claims drafted in one format or statutory type (e.g., apparatus) are intended to support corresponding claims of another format or statutory type (e.g., method).

Because this disclosure is a legal document, various terms and phrases may be subject to administrative and judicial interpretation. Public notice is hereby given that the following paragraphs, as well as definitions provided throughout the disclosure, are to be used in determining how to interpret claims that are drafted based on this disclosure.

References to a singular form of an item (i.e., a noun or noun phrase preceded by “a,” “an,” or “the”) are, unless context clearly dictates otherwise, intended to mean “one or more.” Reference to “an item” in a claim thus does not, without accompanying context, preclude additional instances of the item. A “plurality” of items refers to a set of two or more of the items.

The word “may” is used herein in a permissive sense (i.e., having the potential to, being able to) and not in a mandatory sense (i.e., must).

The terms “comprising” and “including,” and forms thereof, are open-ended and mean “including, but not limited to.”

When the term “or” is used in this disclosure with respect to a list of options, it will generally be understood to be used in the inclusive sense unless the context provides otherwise. Thus, a recitation of “x or y” is equivalent to “x or y, or both,” and thus covers 1) x but not y, 2) y but not x, and 3) both x and y. On the other hand, a phrase such as “either x or y, but not both” makes clear that “or” is being used in the exclusive sense.

A recitation of “w, x, y, or z, or any combination thereof” or “at least one of . . . w, x, y, and z” is intended to cover all possibilities involving a single element up to the total number of elements in the set. For example, given the set [w, x, y, z], these phrasings cover any single element of the set (e.g., w but not x, y, or z), any two elements (e.g., w and x, but not y or z), any three elements (e.g., w, x, and y, but not z), and all four elements. The phrase “at least one of . . . w, x, y, and z” thus refers to at least one element of the set [w, x, y, z], thereby covering all possible combinations in this list of elements. This phrase is not to be interpreted to require that there is at least one instance of w, at least one instance of x, at least one instance of y, and at least one instance of z.

Various “labels” may precede nouns or noun phrases in this disclosure. Unless context provides otherwise, different labels used for a feature (e.g., “first circuit,” “second circuit,” “particular circuit,” “given circuit,” etc.) refer to different instances of the feature. Additionally, the labels “first,” “second,” and “third” when applied to a feature do not imply any type of ordering (e.g., spatial, temporal, logical, etc.), unless stated otherwise.

The phrase “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

The phrases “in response to” and “responsive to” describe one or more factors that trigger an effect. This phrase does not foreclose the possibility that additional factors may affect or otherwise trigger the effect, either jointly with the specified factors or independent from the specified factors. That is, an effect may be solely in response to those factors, or may be in response to the specified factors as well as other, unspecified factors. Consider the phrase “perform A in response to B.” This phrase specifies that B is a factor that triggers the performance of A, or that triggers a particular result for A. This phrase does not foreclose that performing A may also be in response to some other factor, such as C. This phrase also does not foreclose that performing A may be jointly in response to B and C. This phrase is also intended to cover an embodiment in which A is performed solely in response to B. As used herein, the phrase “responsive to” is synonymous with the phrase “responsive at least in part to.” Similarly, the phrase “in response to” is synonymous with the phrase “at least in part in response to.”

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical). More specifically, this formulation is used to indicate that this structure is arranged to perform the one or more tasks during operation. A structure can be said to be “configured to” perform some task even if the structure is not currently being operated. Thus, an entity described or recited as being “configured to” perform some task refers to something physical, such as a device, circuit, a system having a processor unit and a memory storing program instructions executable to implement the task, etc. This phrase is not used herein to refer to something intangible.

In some cases, various units/circuits/components may be described herein as performing a set of tasks or operations. It is understood that those entities are “configured to” perform those tasks/operations, even if not specifically noted.

The term “configured to” is not intended to mean “configurable to.” An unprogrammed FPGA, for example, would not be considered to be “configured to” perform a particular function. This unprogrammed FPGA may be “configurable to” perform that function, however. After appropriate programming, the FPGA may then be said to be “configured to” perform the particular function.

For purposes of United States patent applications based on this disclosure, reciting in a claim that a structure is “configured to” perform one or more tasks is expressly intended not to invoke 35 U.S.C. § 112(f) for that claim element. Should Applicant wish to invoke Section 112(f) during prosecution of a United States patent application based on this disclosure, it will recite claim elements using the “means for” [performing a function] construct.

Different “circuits” may be described in this disclosure. These circuits or “circuitry” constitute hardware that includes various types of circuit elements, such as combinatorial logic, clocked storage devices (e.g., flip-flops, registers, latches, etc.), finite state machines, memory (e.g., random-access memory, embedded dynamic random-access memory), programmable logic arrays, and so on. Circuitry may be custom designed, or taken from standard libraries. In various implementations, circuitry can, as appropriate, include digital components, analog components, or a combination of both. Certain types of circuits may be commonly referred to as “units” (e.g., a decode unit, an arithmetic logic unit (ALU), functional unit, memory management unit (MMU), etc.). Such units also refer to circuits or circuitry.

The disclosed circuits/units/components and other elements illustrated in the drawings and described herein thus include hardware elements such as those described in the preceding paragraph. In many instances, the internal arrangement of hardware elements within a particular circuit may be specified by describing the function of that circuit. For example, a particular “decode unit” may be described as performing the function of “processing an opcode of an instruction and routing that instruction to one or more of a plurality of functional units,” which means that the decode unit is “configured to” perform this function. This specification of function is sufficient, to those skilled in the computer arts, to connote a set of possible structures for the circuit.

In various embodiments, as discussed in the preceding paragraph, circuits, units, and other elements may be defined by the functions or operations that they are configured to implement. The arrangement of such circuits/units/components with respect to each other and the manner in which they interact form a microarchitectural definition of the hardware that is ultimately manufactured in an integrated circuit or programmed into an FPGA to form a physical implementation of the microarchitectural definition. Thus, the microarchitectural definition is recognized by those of skill in the art as structure from which many physical implementations may be derived, all of which fall into the broader structure described by the microarchitectural definition. That is, a skilled artisan presented with the microarchitectural definition supplied in accordance with this disclosure may, without undue experimentation and with the application of ordinary skill, implement the structure by coding the description of the circuits/units/components in a hardware description language (HDL) such as Verilog or VHDL. The HDL description is often expressed in a fashion that may appear to be functional. But to those of skill in the art in this field, this HDL description is the manner that is used to transform the structure of a circuit, unit, or component to the next level of implementational detail. Such an HDL description may take the form of behavioral code (which is typically not synthesizable), register transfer language (RTL) code (which, in contrast to behavioral code, is typically synthesizable), or structural code (e.g., a netlist specifying logic gates and their connectivity). The HDL description may subsequently be synthesized against a library of cells designed for a given integrated circuit fabrication technology, and may be modified for timing, power, and other reasons to result in a final design database that is transmitted to a foundry to generate masks and ultimately produce the integrated circuit. Some hardware circuits or portions thereof may also be custom-designed in a schematic editor and captured into the integrated circuit design along with synthesized circuitry. The integrated circuits may include transistors and other circuit elements (e.g., passive elements such as capacitors, resistors, inductors, etc.) and interconnect between the transistors and circuit elements. Some embodiments may implement multiple integrated circuits coupled together to implement the hardware circuits, and/or discrete elements may be used in some embodiments. Alternatively, the HDL design may be synthesized to a programmable logic array such as a field programmable gate array (FPGA) and may be implemented in the FPGA. This decoupling between the design of a group of circuits and the subsequent low-level implementation of these circuits commonly results in the scenario in which the circuit or logic designer never specifies a particular set of structures for the low-level implementation beyond a description of what the circuit is configured to do, as this process is performed at a different stage of the circuit implementation process.

The fact that many different low-level combinations of circuit elements may be used to implement the same specification of a circuit results in a large number of equivalent structures for that circuit. As noted, these low-level circuit implementations may vary according to changes in the fabrication technology, the foundry selected to manufacture the integrated circuit, the library of cells provided for a particular project, etc. In many cases, the choices made by different design tools or methodologies to produce these different implementations may be arbitrary.

Moreover, it is common for a single implementation of a particular functional specification of a circuit to include, for a given embodiment, a large number of devices (e.g., millions of transistors). Accordingly, the sheer volume of this information makes it impractical to provide a full recitation of the low-level structure used to implement a single embodiment, let alone the vast array of equivalent possible implementations. For this reason, the present disclosure describes structure of circuits using the functional shorthand commonly employed in the industry.

1. An apparatus, comprising:
shader processor circuitry configured to execute instructions of shader programs;
texture storage circuitry configured to store surface data; and
texture processor circuitry configured to access the texture storage circuitry;
wherein:
the shader processor circuitry is configured to execute a multi-fetch instruction that specifies:
an access location and shape information for a thread; and
return sequence information that indicates an ordering of return data for the multi-fetch instruction; and
the texture processor circuitry is configured to, based on the multi-fetch instruction and the shape information:
access multiple texels of a surface stored by the texture storage circuitry, wherein a plurality of the multiple texels are accessed at least partially in parallel; and
provide the accessed multiple texels to the shader processor circuitry for the thread, over multiple clock cycles, according to the ordering specified by the return sequence information.

2. The apparatus of claim 1, wherein:
the texture processing circuitry includes:
a first filter pipeline that includes a first set of multiple sample lanes; and
a second filter pipeline that includes a second set of multiple sample lanes; and
control circuitry configured to map the accesses to the multiple texels of the surface to multiple samples lanes of the first set of multiple sample lanes and to multiple sample lanes of the second set of multiple sample lanes.

3. The apparatus of claim 1, wherein:
the multi-fetch instruction further specifies sparsity mask information that indicates a subset of texels within a shape specified by the shape information; and
the multiple texels accessed and provided by the texture processor circuitry include only the subset of texels and does not include one or more other texels within the shape.

4. The apparatus of claim 1, wherein the shape information indicates a width and a height in texture space.

5. The apparatus of claim 1, wherein the texture processor circuitry is configured to access the multiple texels from the texture storage circuitry in a single clock cycle.

6. The apparatus of claim 1, wherein the texture processor circuitry is configured to store the multiple accessed texels in multiple general-purpose registers of the shader processor circuitry.

7. The apparatus of claim 1, wherein the access location is specified as an integer coordinate in a texture space.

8. The apparatus of claim 1, wherein:
the texture processor circuitry includes filter circuitry configured to perform filter operations on multiple accessed texels; and
the texture processor circuitry is configured to disable the filter circuitry for the multi-fetch instruction and provide the multiple texels without filtering.

9. The apparatus of claim 1, wherein the shape information is encoded to specify a shape, relative to the access location in texture space, wherein the encoding supports two or more of the following shapes:
1×2 texels, 2×1 texels, 1×4 texels, 4×1 texels, and 2×2 texels.

10. The apparatus of claim 1, wherein the multi-fetch instruction is a single-instruction multiple-thread (SIMT) sample instruction and the texture processor circuitry is configured to access multiple texels of the texture for a first SIMT thread and multiple texels of the texture for a second SIMT thread.

11. The apparatus of claim 1, wherein the texture storage circuitry is a texture cache with entries that are tagged based on locations in texture space.

12. The apparatus of claim 1, wherein the apparatus is a computing device that further includes:
a central processing unit;
a display; and
network interface circuitry.

13. A method, comprising:
executing, by shader processing circuitry of a computing system, a multi-fetch instruction that specifies:
an access location and shape information for a thread; and
return sequence information that indicates an ordering of return data for the multi-fetch instruction; and
accessing, by texture processor circuitry of the computing system based on the multi-fetch instruction and the shape information, multiple texels of a surface stored by texture storage circuitry, wherein a plurality of the multiple texels are accessed at least partially in parallel; and
providing, by the texture processor circuitry, the accessed multiple texels to shader processor circuitry for the thread, over multiple clock cycles, according to the ordering specified by the return sequence information.

14. The method of claim 13, further comprising:
mapping, by the computing system, the accesses to the multiple texels of the surface to multiple samples lanes of a first set of multiple sample lanes of a first filter pipeline and to multiple sample lanes of a second set of multiple sample lanes of a second sample pipeline.

15. The method of claim 13, wherein:
the multi-fetch instruction further specifies sparsity mask information that indicates a subset of texels within a shape specified by the shape information; and
the multiple texels include only the subset of texels corresponding to the sparsity mask and does not include one or more other texels within the shape.

16. The method of claim 13, wherein the shape information indicates a width and a height in texture space.

17. The method of claim 13, wherein:
the accessing retrieves the multiple texels from a texture cache; and
the providing stores the accessed multiple texels in multiple general-purpose registers of the shader processor circuitry.

18. The method of claim 13, further comprising:
disabling filter circuitry of the texture processor circuitry for the multi-fetch instruction.

19. A non-transitory computer-readable medium having instructions stored thereon that are executable by a computing device to perform operations, comprising:
executing a multi-fetch instruction of the instructions, wherein the multi-fetch instruction specifies:
an access location and shape information for a thread; and
return sequence information that indicates an ordering of return data for the multi-fetch instruction;
wherein the executing includes a shader processor of the computing device controlling a texture processor of the computing device, based on the multi-fetch instruction, to perform operations including:
based on the multi-fetch instruction and the shape information, accessing multiple texels of a surface, stored by texture storage, in parallel; and
providing the accessed multiple texels to the shader processor, according to the ordering specified by the return sequence information for processing the subsequent instructions of the thread.

20. The non-transitory computer-readable medium of claim 19, wherein:
the multi-fetch instruction further specifies sparsity mask information that indicates a subset of texels within a shape specified by the shape information; and
the multiple texels accessed and provided by the texture processor include only the subset of texels and does not include one or more other texels within the shape.
